(19) United States
(12) Patent Application Publication
(10) Pub. No.: US 2021/0397482 A1
(43) Pub. Date: Dec. 23, 2021

(54) METHODS AND SYSTEMS FOR BUILDING PREDICTIVE DATA MODELS

(71) Applicant: EPHEMERAI, LLC, Spotsylvania, VA (US)

(72) Inventor: Robert W. LANTZ, Spotsylvania, VA (US)

(21) Appl. No.: 17/330,897

(22) Filed: May 26, 2021

Related U.S. Application Data
(60) Provisional application No. 63/040,019, filed on Jun. 17, 2020.

(51) Int. Cl. G06F 9/50; G06K 9/62; G06N 20/00

(52) U.S. Cl. CPC G06F 9/5033; G06K 9/6257; G06N 20/00; G06F 9/5044; G06F 9/5038

(57) ABSTRACT

Embodiments provide methods and systems for automating configuration and administration of resources (both hardware and software) which are used to perform data modelling tasks. According to embodiments, a method for data modelling includes receiving an object associated with a data modelling task at a model building platform; fetching, by the model building platform, a job template corresponding to the object and filing the job template with control information; running, by the data modelling platform, a job from the job template to inform a Kubernetes service which training nodegroup resource to use to perform the data modelling task and to provide one or more interfaces to a training container to be used to perform the data modelling task; scheduling, by the data modelling platform, the data modelling task on the training nodegroup resource; and receiving, by the data modelling platform, model metrics associated with a plurality of models which were evaluated as part of the data modelling task and outputting information associated with the received model metrics.

### RELATED APPLICATION

The present application is related to, and claims priority from, U.S. Provisional Patent Application No. 63/040,019, filed Jun. 17, 2020, entitled “MODEL BUILDING PLATFORM” to Robert W. Lantz, the entire disclosure of which is incorporated here by reference.

### TECHNICAL FIELD

The present invention generally relates to machine learning and model generation and, more particularly, to platforms which enable data scientists to generate and train models.

### BACKGROUND

Machine learning models are, essentially, files that have been trained to, for example, recognize certain patterns. Behind each machine learning model are one or more training algorithms which enable the model to improve its accuracy in recognizing those patterns. There are certain precursor steps in the data science process prior to building a model. For example, a typical machine learning or data science workflow 100 employed to solve a business problem is illustrated in FIG. 1. Therein, at step 102 the data to be used in the process needs to be collected, i.e., aggregated and stored. Next, at step 104, a data cleaning process is performed so that the data is usable and easily accessible, e.g., stored in a database and accessible using SQL queries. Next, at step 106, exploratory data analysis is performed to identify trends and high level insights in the data to help guide the initial steps of the model building. The model building itself occurs in step 108, wherein one or more models are built by selecting a machine learning algorithm, inputting values for various hyperparameters used by the machine learning algorithm and applying the data to train the model. The model built in step 108 is intended to predict future outcomes associated with the business problem. The last step is model deployment 110 wherein the selected model or models are put into deployment, e.g., by making them scalable for their business.

Within this workflow 100, there are many iterative steps for which data scientists typically collaborate in teams. For example, after a model is built, the team needs to identify appropriate values for, e.g., thousands of parameters to train and optimize that model. Developer teams typically obtain these values through trial and error by iterating over hundreds of experiments. Additionally, these teams often build dozens of different models to find the model (or set of models) that best solves the business problem that they are tackling, and each model has an associated set of machine learning artifacts (such as training data).

Not surprisingly, a number of tools and platforms have been developed to assist data scientist teams to coordinate their collaborations in developing machine learning models and to provide the significant data processing resources used to train the models. For example, Amazon's SageMaker provides a number of algorithm selection, model training and deployment tools that are intended to reduce the amount of time that it takes for a development team to create and evaluate their models. When ready for deployment SageMaker deploys each model to an auto-scaling cluster of Amazon EC2 instances which provide varying amounts of CPU cores, memory, storage and network performance. However, SageMaker is wholly dependent upon Amazon Web Services and does not, therefore, provide a model generation solution that is portable to independent computer networks.

Another such platform is Databricks which offers a Spark-backed notebook environment with a straightforward interface for model generation and training. However the Databricks platform is tied to Apache Spark open source cluster networking and, therefore, also does not offer a solution that is portable to other computer architectures. Further, advanced use-cases require significant effort to bundle custom training code, adding burden to an already difficult process.

A third such platform is DataRobot, which automates the testing and validation of myriad model types concurrently and which can be installed on computer networks which are on the premises of the data scientist team or in the cloud, thereby offering a portable solution that is not provided by SageMaker or Databricks. However, DataRobot has its own shortcomings, e.g., hiding the math, which makes model interrogation and learning very difficult. That is, many of the particulars of algorithmic tuning and feature generation are abstracted from the data scientist. The practitioner is required to spend their time configuring the platform, while the experimentation and feature generation is opaque. This arrangement both limits the inherent learning achieved by the data scientist, and introduces unnecessary opacity to the resulting models which limits their applicability to mission problems.

In addition all three of the above-described platforms suffer in that they lag the state of the art relative to the ever expanding capabilities being developed in the open source communities for machine learning, i.e., they are not easily or frequently updated with new machine learning techniques released as open source code.

Accordingly, it would be desirable to provide model building tools and platforms which overcome the afore-described drawbacks.

### SUMMARY

Embodiments enable automating configuration and administration of resources (both hardware and software) which are used to perform data modelling tasks.

According to an embodiment, a method for data modelling includes receiving an object associated with a data modelling task at a model building platform; fetching, by the model building platform, a job template corresponding to the object and filing the job template with control information; running, by the data modelling platform, a job from the job template to inform a Kubernetes service which training nodegroup resource to use to perform the data modelling task and to provide one or more interfaces to a training container to be used to perform the data modelling task; scheduling, by the data modelling platform, the data modelling task on the training nodegroup resource; and receiving, by the data modelling platform, model metrics associated with a plurality of models which were evaluated as part of the data modelling task and outputting information associated with the received model metrics.

According to an embodiment, a model building platform for automating aspects of data modelling includes a control module configured to receive an object associated with a data modelling task; a training service configured to fetch a job template corresponding to the object and filing the job template with control information; wherein the training service is further configured to run a job from the job template to inform a Kubernetes service which training nodegroup resource to use to perform the data modelling task and to provide one or more interfaces to a training container to be used to perform the data modelling task; wherein the Kubernetes service is configured to schedule the data modelling task on the training nodegroup resource; and wherein the control service is further configured to receive model metrics associated with a plurality of models which were evaluated as part of the data modelling task and to output information associated with the received model metrics.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a data modelling process;

FIG. 2 shows a data modelling system according to an embodiment;

FIG. 3 depicts the model building platform of FIG. 2 in more detail according to an embodiment;

FIG. 4 shows an interface library between a notebook environment and a control module of the model building platform according to an embodiment;

FIG. 5 illustrates a flowchart of a simple model training process according to an embodiment;

FIG. 6 is a diagram of various elements of a model building platform according to an embodiment;

FIG. 7 shows a flowchart of a new container creation process according to an embodiment;

FIG. 8 illustrates a processing node or server which can be used to implement embodiments; and

FIG. 9 depicts an electronic storage medium on which computer program embodiments can be stored.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, there are problems associated the current tools and platforms which are available to assist data scientists during the model building phase of a data science project. In particular, data scientists may want to perform simple or more advanced model training for their models. Alternatively, data scientists may, at times, want modelling results to be available more quickly, requiring the use of larger processing resources. In addition data scientist may want to be able to rapidly switch to newly generated, e.g., open source, model training types for their models. All of these features may be desirable to enable to meet the objective of rapid experimentation, without the data scientists themselves having to install modelling code from one processing resource to another, configure the new processing resource to perform the modelling and training requested by the data scientist, as well as perform any administrative tasks associated with the modelling and training.

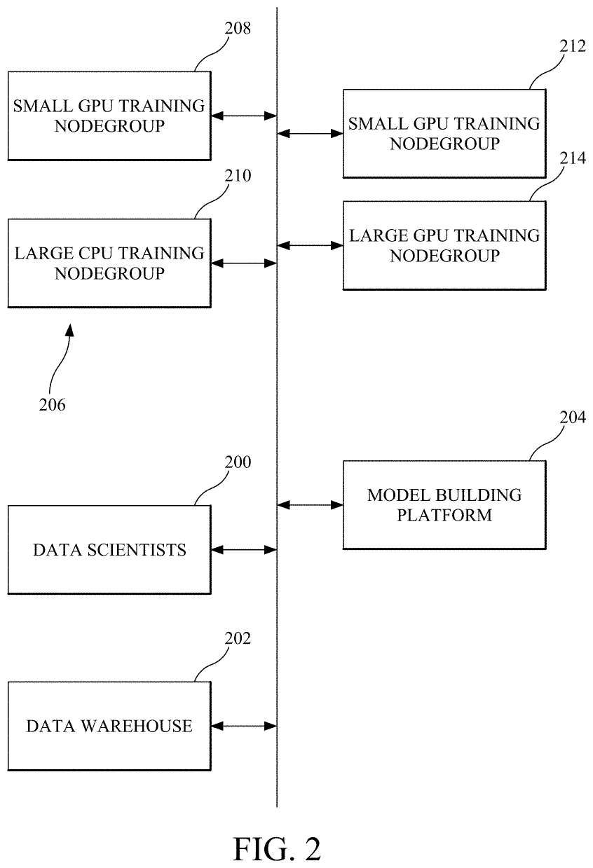

Embodiments described herein enable automation of all of the above described tasks, so that the data scientists can focus on the math associated with the modelling process and evaluating results of the model training. To begin the discussion of such embodiments, consider first an exemplary environment in which models are built as generally described in FIG. 2.

Therein, a group of data scientists have workstations 200 which they use to interact with their data modeling tools via one or more communication interfaces 202 (e.g., Internet, private networks, VPNs, etc.) represented by a single interconnect 202 for simplicity of the Figure. The data scientists have access to a repository of raw data stored in a data warehouse 204 to use for modelling purposes. Embodiments described herein provide for a model building platform 206 which the data scientists use to create models using the data in the data warehouse 202 and various training resources 206, e.g., one or more model training nodegroups 206. The model training nodegroups 206 can be architected to provide more or less powerful computing resources. For the purposes of this discussion, consider that the nodegroups 206 include one or more small CPU training nodegroups 208, one or more large CPU training nodegroups 210, one or more small GPU training node groups 212 and one or more large GPU training node groups 214.

The different types of nodegroups 208, 210, 212, and 214 can be distinguished by their processing power and cost parameters. Using Amazon Web Services nodegroups as a purely illustrative example, these different nodegroups could have the following parameters:

| Name | Type | Memory | Cost |
|---|---|---|---|
| Small CPU Nodegroup | m5.4xlarge | 64 Gb | $0.768/hour |
| Large CPU Nodegroup | m5.24xlarge | 384 Gb | $4.608/hour |
| Small GPU Nodegroup | p3.2xlarge | 61 Gb | $3.06/hour |
| Large GPU Nodegroup | P3.16xlarge | 488 Gb | $24.48//hour |

Those skilled in the art will appreciate that these are just examples of different nodegroup types which can be used in conjunction with data modelling and training and that other nodegroup types could also be used in conjunction with these embodiments which enable model training to be automatically configured, installed and adapted to different types of training nodegroups.

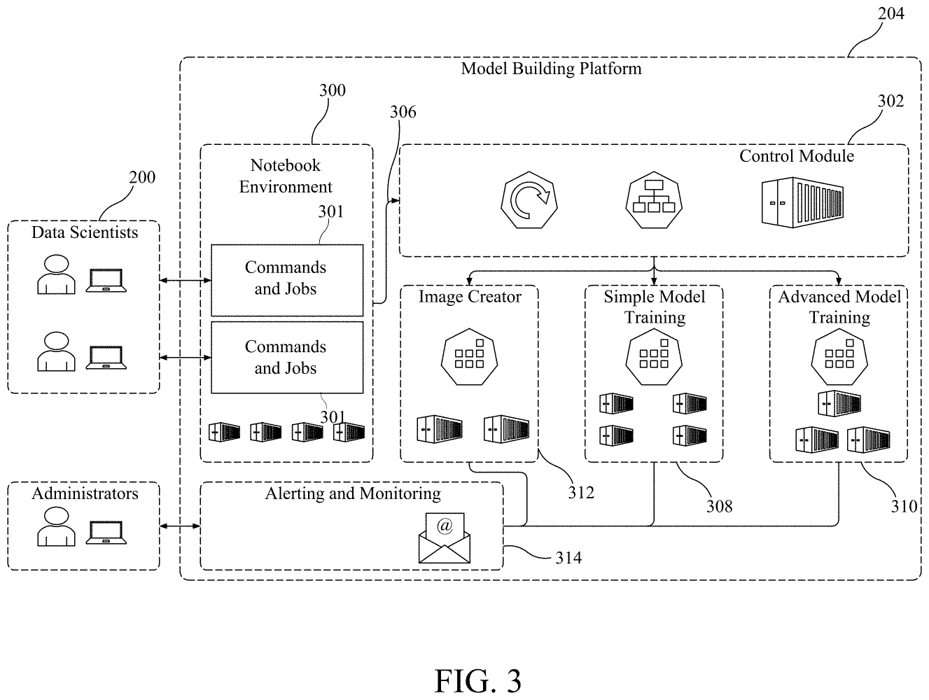

FIG. 3 illustrates a more detailed view of part of the system of FIG. 2, in particular the model building platform 204. Therein, the data scientists' workstations 200 can communicate with the model building platform 204 via a plurality of notebook environments 300 (i.e., a coding environment), e.g., one per data scientist. The notebook environment 300 is, according to this embodiment, a customized version of JupyterHub, which is an open source project that allows users to use shared resources to create their own notebooks (code environments). Although the notebook environments 300 are illustrated as part of the model building platform 204, and can run on the same, always running hardware (e.g., a small CPU model training nodegroup 208), according to other embodiments the notebook environments 300 and the rest of the model building platform 204 can be running on different hardware nodes. According to embodiments, the notebook environments 300 can be implemented as custom user interfaces (UI) which will provide a streamlined set of views to include, but not limited to Infrastructure Status, Job Management, Code Management, Artifact Management, Team Collaboration, and User Preferences. By exposing a custom UI, embodiments are able enforce granular Role Based Access Controls (RBAC) and alleviate the need to manage the same user across the many platforms the system is comprised of. Additionally, the UI serves as a way to provide a consistent brand across the model building platform 204, allowing users to navigate the different platform functions without prior knowledge of the underlying platforms.

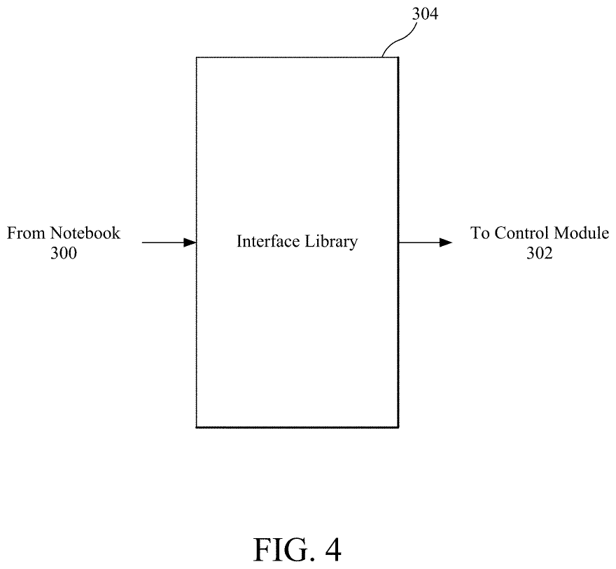

The notebook environments 300 issue commands and jobs 301 to the control module 302 of the model building platform 204 via an interface library 304, which according to an embodiment is a Python module that allows the notebooks 300 to interact with the rest of the model building platform 204. The interface library 304 is represented in FIG. 3 by an arrow 304, but will now be described in more detail with respect to FIG. 4.

The following is a list of commands and jobs which can be communicated by the notebooks 300, translated by the interface library 304 and then forwarded on to the control module 302 for processing as generally shown in FIG. 4. The client-side (notebook) interface library 304 is designed to translate the standard training method signatures into an Application Programming Interface (API) that then instructs the platform 204 regarding how to configure the job to perform the task required. In this embodiment, the library 304 has two primary sub-modules: creator and jobs which are described below.
Creator
   docker—Contains an ‘Imager’ class with methods that enable the user to, starting with a base container image, create their own custom data conditioning or model training docker image that can then be immediately used for data conditioning or model training jobs.
Jobs
   training—Contains a Trainer class with the run_job method whose signature mirrors that of standard fit methods in common use in the data science community. This module is intended to address the simple model training use-case.
   training_x—Contains a Trainer class with a run_job method with a more flexible signature. This module addresses a more advanced use case that can deploy more sophisticated model training jobs. It integrates with version control services and accepts arbitrary, user defined arguments.
   conditioning_x—Contains a Conditioner class run_job method that is similar to the training_x module's run_job method. This module is intended to address potentially complex data conditioning tasks.

Returning to FIG. 3, the control module 302 kicks off each process initiated by the data scientists 200 toward the model building platform 204, e.g., performing simple model training via module 308, performing advanced model training via module 310 or creating a new image container via module 312. For example, simple model training can be performed using the simple training module 308 to configure a model training run specified by data scientists 200 on a small CPU training nodegroup 208 or a small GPU training nodegroup 212 using a selected (relatively) simple machine learning method, e.g., Scikit-Learn v0.22.0 (Random Forest, etc the baseline Python Machine Learning module) or LightGBM v2.3.1 (Light Gradient Boosting—a more recent advancement developed by Microsoft). Alternatively, advanced model training can be performed using the advanced training module 308 to configure a model training run specified by data scientists 200 on a large CPU training nodegroup 210 or a large GPU training nodegroup 214 using a selected more advanced (and hence more processing power intensive) machine learning method, e.g., PyTorch v1.5.0 (Tensor Framework—the neural network library supported by Facebook) or PyTorch v1.5.0 w/CUDA (Tensor Framework—same as above, but with the CUDA framework installed that enables GPU training).

Each of these three modules 308, 310, 312 will be described below in more detail in the context of various hypothetical data modelling tasks that data scientists 200 might use the model building platform 204 to perform. The model building platform 204 also includes an alerting and monitoring module 314 which informs administrators 316 about the results of the data modelling jobs performed by the platform 204.

To better understand how the control module 302 receives data modelling commands or jobs from the notebook environment 300 via interface 306 and automatically generates and runs data modelling tasks using a selected one of the simple model training module 308, the advanced model training module 310 and the image creator module 312 according to these embodiments, consider a hypothetical data client Insura-Co which provides automobile insurance. Insura-Co has a massive data warehouse 202 which stores billions of by-minute observations for cars in their network, i.e., raw data which is not so useful for modeling in its initial form. This data exists in a large, relational database. The Insura-Co Data Scientists 200 have accessed their large, not-useful-for-modeling data warehouse 202, explored it, and created a modeling data set where each row is a “driver-day”. Each column is a feature of a driver's day that has been calculated by the data scientist 200 and determined to have potential predictive value (e.g. the previous weekly average velocity, the farthest distance they've traveled from home in the last day, whether or not the car starts the day at home, whether or not the car's oil change is up-to-date, etc).

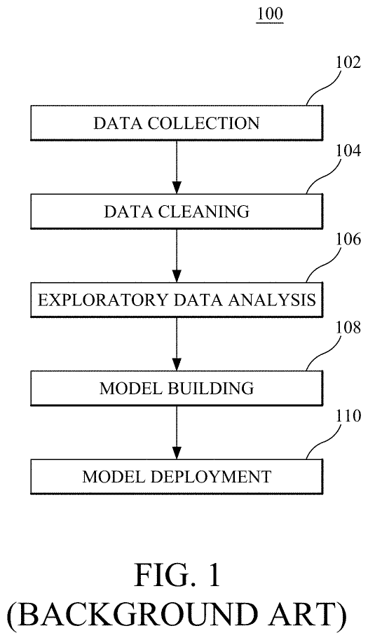

Now the data scientists 200 have a 10M record dataset of 150 columns. This can be considered to be the output of, for example, steps 102, 104 and 106 in the workflow of FIG. 1 described above. The data scientists 200 want to use data modeling on that data to infer whether or not a driver is likely to have an accident today. The data scientists 200 decide to start with a simple Random Forest (RF) model, so they define a training run to find the best version of the RF algorithm for this data, i.e., performing some version of hyperparameter search to identify an optimized RF algorithm for this data and the predictive objective of the model. As will be appreciated by those skilled in the art, hyperparameters are the parameters that define how the algorithm goes about its work. For instance, the number of trees in the forest is a hyperparameter of the RF algorithm. So a training run will try models from many versions of the RF algorithm, on the order of hundreds to thousands of combinations of hyperparameters to try to identify one or more “best” RF models in this context.

The data scientists 200 in this example define the training run as an object in code. A conventional block of Python code which could be generated by the data scientists 200 to define this training run is illustrated below as Code Block 1.

Code Block 1

| | |
|---|---|
| [1]: | from lightgbm import LGBMClassifier |
| | from sklearn.model_selection import GridSearchCV |
| | lg_param = { |
| | ”boosting_type”: [’dart’], |
| | ”n_estimators”: [75, 125], |
| | ”max_depth”: [5, 1∅], |
| | ”num_leaves”: [12, 24], |
| | ”reg_alpha”: [∅, 1], |
| | ”reg_lumbda”: [∅, 1] |
| | } |
| | x_data = x_data # o dataframe or matrix representing inputs |
| | y_data = y_data # o serires or vector representing outputs to infer/predict |
| | gbc = LBGMClassifier( ) |
| | clf = GridSearchCV( |
| | gbc, |
| | lg_parms, |
| | cv [symbol] S, |
| | n_jobs = 1∅, |
| | scoring = ’recall_macro’ |
| | ) |
| | clf.fit(X_train, y_train) |

[symbol]

indicates data missing or illegible when filed

By way of contrast, embodiments of the model building platform 204 could receive the same training run by way of the code example below (Code Block 2) generated by data scientists 200.

Code Block 2

| | |
|---|---|
| [5]: | from startaker.jobs import training |
| | lg_param [symbol] { |
| | ”boosting_type”: [’dart’], |
| | ”n_estimators”: [75, 125], |
| | ”max_depth”: [ [symbol] , 1∅], |
| | ”num_leaves”: [12, 24], |
| | ”reg_alpha”: [∅, 1], |
| | ”reg_lumbda”: [∅, 1] |
| | } |
| | x_data = x_data |
| | y_data = y_data |
| | parts = run_dict[ [symbol] X_train [symbol] ][1] # additional feature |
| | algorithm = [symbol] LGBMClassifier’ # name the algorithm instead of explicit invocation |
| | image_tag = [symbol] lgbm2.3.1’ # which container image to use |
| | node_type = [symbol] cup’ # what kind of computer to use (′cpu′ or ′gpu′) |
| | job_lg = training.Trainer( |
| | name= [symbol] sentlment-lgbm’, # give the job a name for later inspection |
| | bucket= [symbol] cloudfram-email-app’, # which object storgae to use |
| | image_tag=image_tag, |
| | cluster_name= [symbol] startaker-day’, # where to run it |
| | mem_limit=’126’, # tell it how much memory to reserve and use |
| | mem_guarantee= [symbol] 96’, |
| | node_type=node_type |
| | ) |
| | job_lg.run_job( |
| | algorithm=alogorithm, # all very similar to the GridSearchCV above |
| | hyperparameters=lg_params, |
| | scoring= [symbol] recall_macro’, |
| | x_data=X_data, |
| | y_data=y_data, |
| | cv=3, |
| | n_jobs=3, |
| | parts=parts |
| | } |

[symbol]

indicates data missing or illegible when filed

Comparing Code Block 1 with Code Block 2 illuminates some of the differences and benefits of model building platform 204 according to some of the embodiments. Consider first of all that the hyperparameters (shown in the top portion of each Code Block as the set Ig_params) are the same for both Code Blocks, indicating that the two different Code Blocks are running the same training algorithm albeit Code Block 2 enables the model building platform 204 to automate the configuration and administration of the model training resources whereas Code Block 1 does not.

Consider next the differences between the two Code Blocks. Code Block 1 is essentially hard coded to first create a number of different models (i.e., the clf=GridSearchCV block) based on the provided hyperparameters and then train those created models against the data (i.e., the clf.fit(X.train, y.train) block). By way of contrast, model building platform uses Code Block 2 to not only create and train the models, but to also automate the configuration and administration of the code and hardware resources needed to perform the training.

For example, Code Block 2, according to this embodiment, includes the extra parameters “parts”, “algorithm”, “image_tag” and “node_type” which are not found in Code Block 1. The “parts” parameter is a custom embellishment that can read file parts and assemble them on the nodegroup's hardware. The “algorithm” parameter enables the model building platform 204 to be told which of a plurality of model training algorithms to use rather than that choice being hardcoded into the invocation code blocks. The “image_tag” parameter tells the model building platform 204 which image container to use train the models. Image containers can be generated by image creator 312 which is described in more detail below. The “node_type” parameter tells the model building platform which type of training node group 208, 210, 212 or 214 to use to perform the model training.

The job_Ig=training portion of Code Block 2 performs configuration tasks of the resource(s) to be used to perform the model training according to this embodiment. The “name” parameter provides a name for the job to be used by the data scientists 200 to recognize and inspect the job results. The “bucket” parameter identifies which storage location to use to store the job results. The “image_tag” parameter reuses the previously specified “image_tag” parameter to specify the container to use for the training run. The “cluster name” parameter specifies the specific one (or more) of the node training groups 208, 210, 212 or 214 on which to run the training job. The “mem_limit” parameter tells the model training platform 204 the maximum amount of computer memory to reserve for running the job. The “mem_guarantee” parameter tells the model training platform 204 the minimum amount of computer memory that needs to be guaranteed for running the job . . . . The mem_limit parameter gives the job an upper bound on the amount of resource it can consume. The mem_guarantee parameter likewise gives the job a lower bound, ensuring that a competing job doesn't get scheduled on the same hardware, and potentially creating a resource conflict. Lastly, the “node_type” parameter informs the model building platform 204 of the type of computer hardware resource to use, e.g., a cpu or gpu.

As will be appreciated by those skilled in the art, cpu hardware architecture typically involves a smaller number of faster cores (processors), e.g., 24-48, with a larger instruction set relative to gpu hardware architecture which typically involves a larger number of somewhat slower cores, e.g., thousands of cores, with a smaller instruction set. This generally makes cpu hardware architecture more versatile (due to the larger instruction set) but slower for certain types of tasks than the gpu hardware architecture, which offers massive parallelism that can be very useful for complex or advanced data model training jobs. Embodiments described herein enable the data scientists 200 to easily select (and switch between) model training runs which use a cpu training nodegroup 208 or 210 and model training runs which use a gpu training nodegroup 212 and 204. Moreover, these embodiments automate the process of configuring either the cpu training nodegroup or the gpu training nodegroup in a manner which is opaque to the data scientists 200. In particular, configuring and administrating a gpu training nodegroup 212 or 214 to perform model training runs has historically been sufficiently daunting (and expensive) that many data scientists have opted to use cpu training nodegroups simply to avoid the complexities and costs associated with employing gpu architectures. Examples of how embodiments automate gpu configuration and administrative tasks are provided below as part of a more detailed example of the advanced model training module 310's operation.

Code Block 2 also includes a job.lg=run_job portion of code which operates to actually perform the desired model training runs on the now configured training nodegroup resource(s). However, whereas clf.fit(X.train, y.train) of Code Block 1 would run on the host machine (i.e. the same place the notebook 300 is running), and thus the data scientists 200 would be waiting on the results of that model training run to come back before they are able to use their notebooks 300 to start other tasks, the run_job call of the embodiment of Code Block 2 uses a different computing resource to perform the model training and instead returns control of the notebook 300 almost immediately to the data scientists 200 so that they can continue to work in parallel with the model training runs being performed.

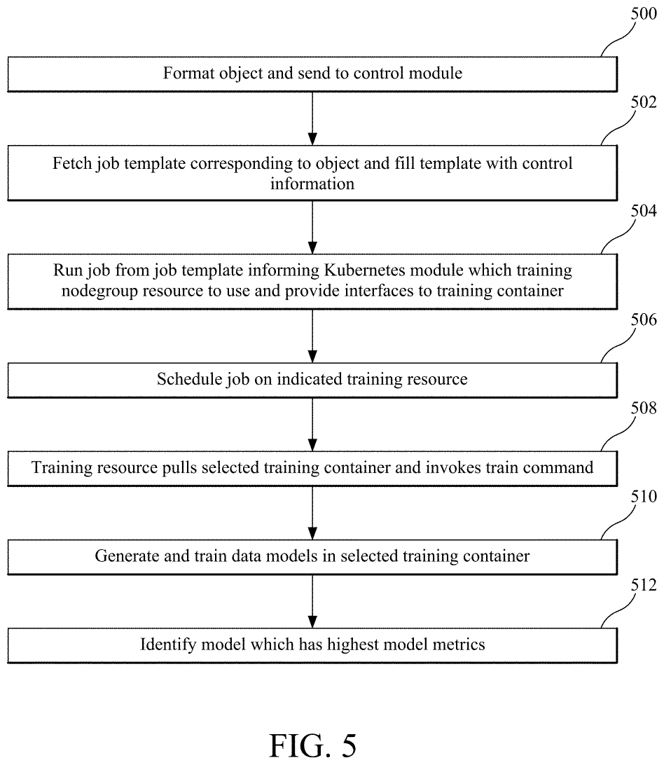

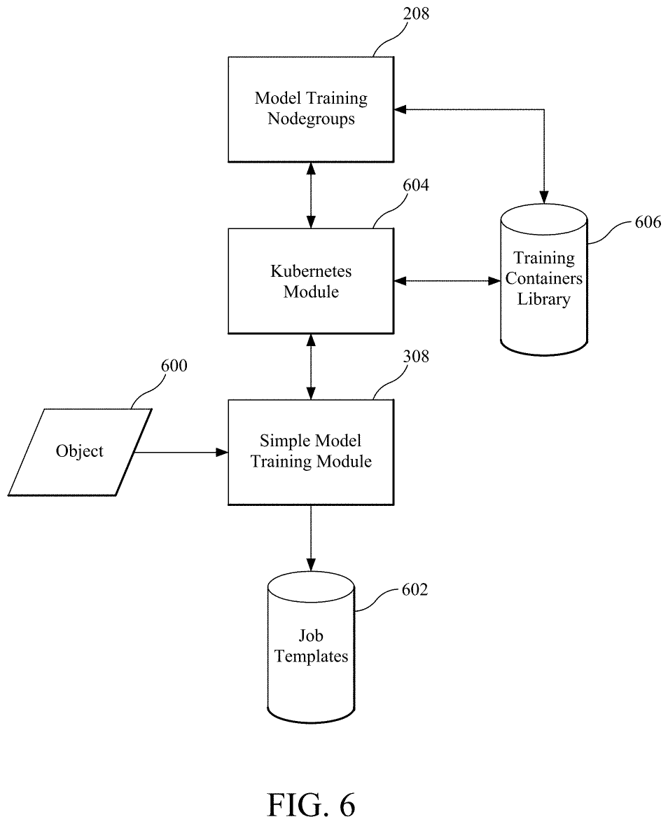

Next the description will provide some functional examples of how embodiments use the simple model training module 308, image creator module 312 and advanced model training module 310 to enable automated configuration of training nodegroup resources. Starting with the simple model training module 308, when the data scientists invokes run_job in the notebook environment 300 a number of operations occur, all of which are automated by the model building platform 204 and which, therefore, are opaque to the data scientist 200. These operations are illustrated in the flow diagram of FIG. 5 and the object diagram of FIG. 6.

First, at step 500, an object 600 is formatted for the simple model training module 308 by the interface library 306 (described above, e.g., Code Block 2), and the object 600 is sent to the control module 302/simple model training module 308. The simple model training module 308, at step 502 fetches the correct job template 602 and fills the template 602 in with the correct information based on the object 600, including a formatted training command that is appropriate to the task. The simple model training service 308 then runs the job using the job template 602 at step 504, which tells a Kubernetes service 604 what resources to use, and ensures that the Kubernetes service 604 interfaces with the correct training container 606, and that the training container 606 receives the information that the training container needs.

As will be appreciated by those skilled in the art, Kubernetes is an open source system for scheduling and running containerized applications across a cluster of machines. Containerized applications are applications which enable an entire system (e.g., operating system, application software, dependencies, etc.) to be installed, configured and run independently of the host system. The model building platform 204 according to embodiments is built using the Kubernetes ecosystem and uses a Kubernetes service 604 internally to interact with itself which enables data scientists 200 to more easily and efficiently work with Kubernetes to generate and run model training jobs.

Returning to FIG. 5, at step 506, after the job is run, the Kubernetes service 604 schedules the job on the correct training resource(s), e.g., one of the model training nodegroups 208 in this simple model training example. If that training resource 208 does not exist or the existing resources are too busy, the Kubernetes service 604 will turn on a new resource 208. As soon as the assigned training resource 208 is on, the training resource 208 pulls the correct training container 606, and then invokes a ‘train’ command at step 508 which was received in the object 600. The train command sets up the code on the training container 606 to perform the modelling specified by the data scientists 200 in their “run job” message from the notebook environment 300.

The train command logs data loading progress, import validation, and intermediate and final model performance metrics, and performs the math needed to check thousands of models against each other to determine which one is the best at steps 510 and 512. In this context the “best” model identified during this training run may or may not necessarily be the model which is mathematically the most predictively accurate of the question which the data scientists 200 are trying to answer but may instead be the model which scores highest on other or additional model metrics that were provided by the data scientists 200. When the training is finished the model training utility returns the results to the simple model training service 308 which writes the “best” model to a location 314 that's accessible to the data scientists 200 as well as the logs associated with the training run for their inspection. If the training resource 208 is idle after that (no other jobs need done) it will shut down automatically. The data scientists 200 would then pull that “best” model object into the notebook 300 and run some metrics on that model to confirm its performance. While the data scientists have been waiting on the training of the RF model to complete they are free to repeat the process for the LightGBM algorithm since the RF model training was performed on the resource 208 rather than the host environment of the notebook 300.

Turning now from the simple model training service 308 consider the image creator service 312. As mentioned in the Background, one of the shortcomings of existing platforms is their inability to quickly adapt to new versions of, e.g., open source data modelling algorithms. Conventionally, a data scientist 200 would need to request a third party company to The image creator module 312 of these embodiments addresses this shortcoming. For example, suppose that the data scientists 200 find out that Scikit-Learn version 0.23.1 has a newer version of the RF algorithm implemented (this can occur by a newly available hyperparameter). Instead of having to wait for a third party to release a new training container image to the training library 606, the data scientists 200 can create the new training container themselves using the image creator module 312 without needing to learn the specifics of how containers are created.

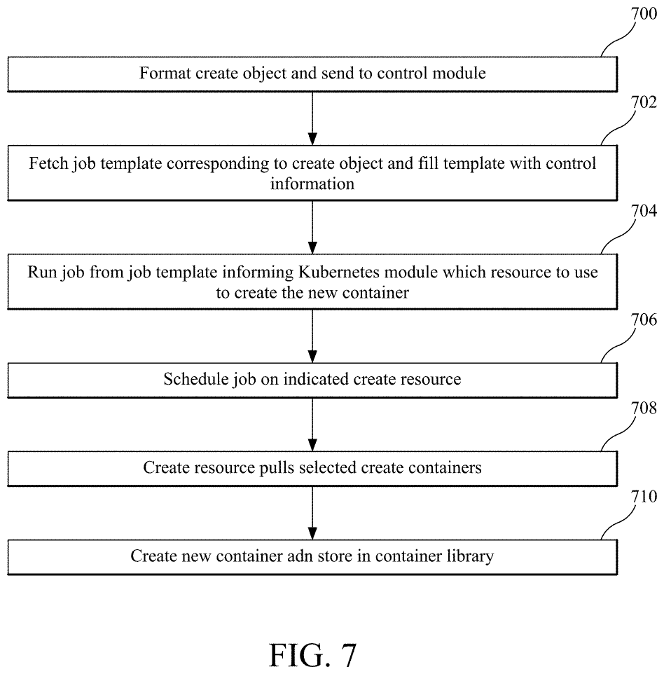

For example, by invoking the ‘create( )’ method available in the notebook environment, the process illustrated in FIG. 7 can be performed to create a new training container to be used by the model building platform the Scikit-Learn version 0.23.1's newer version of the RF algorithm. Therein, at step 700, the interface library formats an object for the control module 302 and sends it to the control module 302. At step 702, the control module 302 pulls a corresponding create job template 602, formats the template 602 appropriately, and applies the template 602 to the Kubernetes module 604 at step 704. The Kubernetes module 604 schedules the create job in the same way as described above for the training model job at step 706, although the create resource requirement is typically much smaller than that for resources assigned to a model training run.

The create computing resource will pull a set of containers 606 that are designed to run “Docker in Docker” (dind) as shown in step 708. As will be appreciated by those skilled in the art, Docker is a system that manages and creates containers. Docker in Docker is the concept of creating and managing containers from within other containers. The model building platform 204 via image creator module 312 implements a custom version of Docker in Docker that allows the user to start from an existing container and add software to it that they are sure does not contain conflicts, and then write the resulting container back to the container repository 606 without outside help. These embodiments modify Docker in Docker to enable the user to perform this operation themselves without needing to learn the specifics of how containers are created.

The following code sample shows how a user can easily, and without knowing anything about Docker, create their own container image for model training. In this case, a newer version of the sklearn package can be bundled into a container used for model training by the model building platform 204, and used immediately after the job's completion.

| | |
|---|---|
| [7]: | img_job = docker.Imager(cluster=’startaker-dev’) |
| | tag_name = [symbol] sklearn∅.23.1’ |
| | package = [ |
| | ( [symbol] sklearn’, [symbol] ∅.23.1’) |
| | ] |
| | img_job.create(tag_name=tag_name, packages=packages, algorithm_path= [symbol] sklearn.ensemble’) |

[symbol]

indicates data missing or illegible when filed

The containers create a new training container with Scikit-Learn 0.23.1 and store it in the library at step 710. Invoking the create method formats an API request for the custom Docker in Docker (DinD) service running in the model building platform platform. The DinD service contains a set of blank dockerfiles which contain the boilerplate code required to create custom images as well as the utility that enables the user to customize the image at the appropriate level. The data scientists 200 are then able to create a new RF model using the newly built training image just as they did in the above-described embodiment with respect to FIGS. 5 and 6 and can then test for themselves if the new RF algorithm is really a better way to find a model for their data. This capability to quickly and easily try newly implemented algorithms is a significant benefit to embodiments described herein.

The embodiments described thusfar provide significant benefits in terms of cost and speed for data modeling. Consider that in this example, the data scientists 200 at Insura-Co started the day with a large dataset ready for modeling and ended it with multiple trained model objects ready for evaluation; all at a minimum possible expense. If the data scientists 200 were instead working solely on their local machines they'd have to wait a week or so for those trained model objects. Alternatively, if the data scientists 200 were using one of the systems described above in the Background section, then they would only have access to the library of available training methods that are provided to them, and they'd be paying for the training resources whether or not they used them.

Next the description will move on to the advanced model training module 310. Consider that Insura-Co is looking into self-driving cars, and they want to determine whether or not the terabytes of image data they have are useful for training a pedestrian detection model. Assuming that the images are tagged with pedestrians, the data scientists 200 could use the advanced model training service 310 to do exactly this. In fact, this is an ideal use case for the advanced model training service plus a large GPU resource. The process is very similar to the simple model training service, but with more customization available to (and necessary from) the data scientists 200. The advanced model training module 310 allows any data scientist to access the same kind of modeling capability available from large data centers without the difficulty or expense of setting it all up or paying for it continuously.

For example, the advanced model training service 310 is built to address advanced use cases where standard fit and transform methods are either not available or do not apply. Whereas the simple model training service 308 uses a custom training utility to wrap the fit and transform to use the appropriate algorithm to train a model, the advanced model training service 310 uses a training utility to run arbitrary model training code with minimal imposition on required elements of that code. The advanced model training service 310 uses the platform 204's integration with a version control system (VCS) (e.g. GitHub) to expose the data scientist's training code to the training container. Benefits associated with the advanced model training module 310 include: the ability to run custom data read functions, the ability to run custom data cleaning functions, the ability to customize logging for job interrogation, the ability to invoke custom algorithms (e.g. user-defined neural network architectures), the ability to implement custom stopping criteria, removing the burden of installing and configuring the software to run computationally intensive jobs and removing the requirement to monitor expensive resources manually.

In order to function properly in conjunction with the advanced training service 310, the code written by the data scientists 200 should: be version controlled on the VCS that is integrated with the platform 204, and contain a training function that is importable by the appropriate modeling language (e.g. Python). That training function may have arbitrary arguments, but should contain at least a “data” argument referencing a string object. How that object is handled is up to the user. These requirements give max flexibility to the user, enabling them to transfer existing projects to the platform with minimal refactor and minimal learning curve.

As an example of how this advanced training service 310 could be used, consider a case where a data scientist wants to build a custom neural network architecture and train a model based on that architecture to predict certain activity from a large set of data. The advanced model training service is maximally flexible in this case. The data scientist can write their own components to train the model including (but not limited to):
Data loading and feature generation (i.e., creating data tensors)
Network layers with hyper-parameters
A loss function that handles the comparison between known values and model outputs

The data scientist merely creates a training function that references a data location, and uses that function to kick off their model training process. All aspects of the process are up to the data scientist. The platform handles the creation of the larger compute infrastructure, and, if necessary, the pre-configured accelerated infrastructure (i.e., GPU) for the code to run on. It also handles logging and the storage of the resulting trained model so the data scientist can access and test results.

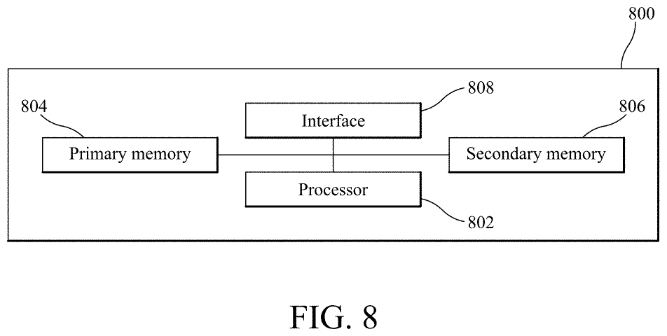

Embodiments described above can be implemented in one or more processing nodes (or servers). An example of a node 800 is shown in FIG. 8. The communication node 800 (or other network node) includes a processor 802 for executing instructions and performing the functions described herein. The communication node 800 also includes a primary memory 804, e.g., random access memory (RAM) memory, a secondary memory 806 which can be a non-volatile memory, and an interface 808 for communicating with other portions of a network or among various nodes/servers in support of charging.

Processor 802 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other communication node 800 components, such as memory 804 and/or 806, node 800 functionality in support of the various embodiments described herein. For example, processor 802 may execute instructions stored in memory 804 and/or 806.

Primary memory 804 and secondary memory 806 may comprise any form of volatile or non-volatile computer readable memory including, without limitation, persistent storage, solid state memory, remotely mounted memory, magnetic media, optical media, RAM, read-only memory (ROM), removable media, or any other suitable local or remote memory component. Primary memory 804 and secondary memory 806 may store any suitable instructions, data or information, including software and encoded logic, utilized by node 800. Primary memory 804 and secondary memory 806 may be used to store any calculations made by processor 802 and/or any data received via interface 808.

Communication node 800 also includes communication interface 808 which may be used in the wired or wireless communication of signaling and/or data. For example, interface 808 may perform any formatting, coding, or translating that may be needed to allow communication node 800 to send and receive data over a wired connection. Interface 808 may also include a radio transmitter and/or receiver that may be coupled to or a part of the antenna. The radio may receive digital data that is to be sent out to other network nodes or wireless devices via a wireless connection. The radio may convert the digital data into a radio signal having the appropriate channel and bandwidth parameters. The radio signal may then be transmitted via an antenna to the appropriate recipient.

It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

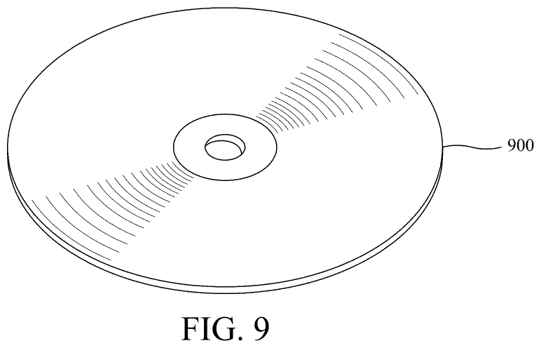

As also will be appreciated by one skilled in the art, the embodiments may take the form of an entirely hardware embodiment or an embodiment combining hardware and software aspects. Further, the embodiments, e.g., the configurations and other logic associated with the modelling process to include embodiments described herein, such as, the methods associated with FIG. 5 or FIG. 7, may take the form of a computer program product stored on a computer-readable storage medium having computer-readable instructions embodied in the medium. For example, FIG. 9 depicts an electronic storage medium 900 on which computer program embodiments can be stored. Any suitable computer-readable medium may be utilized, including hard disks, CD-ROMs, digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

What is claimed is:

1. A model building platform for automating aspects of data modelling comprising:
a control module configured to receive an object associated with a data modelling task;
a training service configured to fetch a job template corresponding to the object and to fill the job template with control information;
wherein the training service is further configured to run a job from the job template to inform a Kubernetes service which training nodegroup resource to use to perform the data modelling task and to provide one or more interfaces to a training container to be used to perform the data modelling task;
wherein the Kubernetes service is configured to schedule the data modelling task on the training nodegroup resource;
wherein the control module is further configured to receive model metrics associated with a plurality of models which were evaluated as part of the data modelling task and to output information associated with the received model metrics; and
wherein the object includes: (a) a parts parameter which enables the training service to read file parts and assemble the file parts on the training nodegroup resource, (b) an algorithm parameter which informs the training service which of a plurality of model training algorithms to use to perform the data modelling task, (c) an image tag parameter which indicates to the model building platform which image container to use to perform the data modelling task and (d) a node type parameter which indicates to the model building platform which type of training nodegroup resource to use to perform the data modelling task.

2. A method for data modelling comprising:
receiving an object associated with a data modelling task at a model building platform;
fetching, by the model building platform, a job template corresponding to the object and filing the job template with control information;
running, by the data modelling platform, a job from the job template to inform a Kubernetes service which training nodegroup resource to use to perform the data modelling task and to provide one or more interfaces to a training container to be used to perform the data modelling task;
scheduling, by the data modelling platform, the data modelling task on the training nodegroup resource; and
receiving, by the data modelling platform, model metrics associated with a plurality of models which were evaluated as part of the data modelling task and outputting information associated with the received model metrics.

3. The method of claim 2, wherein the model building platform includes a notebook environment, a control module, an image creator service, a simple model training service, an advanced model training service and an alert and monitoring service all of which run on a server.

4. The method of claim 2, wherein the training nodegroup resource is one or more of a plurality of central processing units (CPUs) and/or a plurality of graphics processing units (GPUs) which the model building platform can interact with to perform the data modelling task.

5. The method of claim 2, further comprising:
if the training nodegroup resource selected for the Kubernetes service to perform the data modelling task does not exist or is too busy, turning on another training nodegroup resource to perform the data modelling task.

6. The method of claim 2, further comprising:
pulling, by the training nodegroup resource, the training container to be used to perform the data modelling task;
generating and training, by the training nodegroup resource, data models in the training container; and
transmitting, by the training nodegroup resource, model metrics associated with a plurality of models which were evaluated as part of the data modelling task to the model building platform.

7. The method of claim 3, wherein the object received by the model building platform is created within the notebook environment.

8. The method of claim 3, wherein the image creator service operates to create a new container and wherein the method further comprises:
receiving, by the model building platform, a create object associated with the new container;
fetching, by the model building platform, a job template corresponding to the create object and filling in the job template with control information;
running, by the model building platform, a job from the job template to inform the Kubernetes service which training nodegroup resource to use to create the new container; and
scheduling, by the model building platform, the job on the training nodegroup resource.

9. The method of claim 8, further comprising:
pulling, by the training nodegroup resource, one or more selected create container; and
create the new container and store the new container in a container library.

10. The method of claim 2, wherein the model building platform automates configuration of the training nodegroup resource for performance of the data modelling task.

11. A model building platform for automating aspects of data modelling comprising:
a control module configured to receive an object associated with a data modelling task;
a training service configured to fetch a job template corresponding to the object and filing the job template with control information;
wherein the training service is further configured to run a job from the job template to inform a Kubernetes service which training nodegroup resource to use to perform the data modelling task and to provide one or more interfaces to a training container to be used to perform the data modelling task;
wherein the Kubernets service is configured to schedule the data modelling task on the training nodegroup resource; and
wherein the control service is further configured to receive model metrics associated with a plurality of models which were evaluated as part of the data modelling task and to output information associated with the received model metrics.

12. The model building platform of claim 11, wherein the model building platform further comprises a notebook environment, an image creator service, and an alert and monitoring service all of which run on a server.

13. The model building platform of claim 11, wherein the training nodegroup resource is one or more of a plurality of central processing units (CPUs) and/or a plurality of graphics processing units (GPUs) which the model building platform can interact with to perform the data modelling task.

14. The model building platform of claim 11, further comprising:
if the training nodegroup resource selected for the Kubernetes service to perform the data modelling task does not exist or is too busy, turning on another training nodegroup resource to perform the data modelling task.

15. The model building platform of claim 11, further comprising:
wherein the training nodegroup resource is further configured to pull training container to be used to perform the data modelling task;
wherein the training nodegroup resource is further configured to generate and train the data models in the training container; and to transmit model metrics associated with a plurality of models which were evaluated as part of the data modelling task to the model building platform.

16. The model building platform of claim 12, wherein the object received by the model building platform is created within the notebook environment.

17. The model building platform of claim 12, wherein the image creator service operates to create a new container and wherein the model building platform further comprises:
wherein the control module is further configured to receive a create object associated with the new container;
wherein the image creator service is further configured to fetch a job template corresponding to the create object and to fill in the job template with control information;
wherein the image creator service is further configured to run a job from the job template to inform the Kubernetes service which training nodegroup resource to use to create the new container; and
wherein the Kubernetes service is further configured to schedule the job on the training nodegroup resource.

18. The model building platform of claim 17, further comprising:
wherein the training nodegroup resource is further configured to pull one or more selected create container; and to create the new container and store the new container in a container library.

19. The model building platform of claim 11, wherein the model building platform is further configured to automate configuration of the training nodegroup resource for performance of the data modelling task.
